(19) United States
(12) Patent Application Publication
(10) Pub. No.: US 2025/0346079 A1
(43) Pub. Date: Nov. 13, 2025

(54) DEVICE FOR MEASURING A FORCE ACTING ON A KING PIN OF A SEMITRAILER, SEMITRAILER, MULTI-PART VEHICLE

(71) Applicant: ZF CV Systems Global GmbH, Bern (CH)

(72) Inventors: Axel Stender, Hameln (DE); Norbert Witte, Lauenau (DE)

(21) Appl. No.: 19/272,872

(22) Filed: Jul. 17, 2025

Related U.S. Application Data
(63) Continuation of application No. PCT/EP2023/086666, filed on Dec. 19, 2023.

(30) Foreign Application Priority Data
Jan. 19, 2023 (DE) 10 2023 101 340.8

(51) Int. Cl. B60D 1/24

(52) U.S. Cl. CPC B60D 1/248

(57) ABSTRACT

A device measures a force acting on a king pin of a semitrailer. The device includes the king pin and a sensor unit. The sensor unit is configured to ascertain a bending of the king pin caused by the force. The king pin has an opening, and the sensor unit is arranged in at least one of the following locations: in the opening and at one end of the opening.

### CROSS-REFERENCE TO RELATED APPLICATIONS

This application is a continuation application of international patent application PCT/EP2023/086666, filed Dec. 19, 2023 designating the United States and claiming priority from German application 10 2023 101 340.8, filed Jan. 19, 2023, and the entire content of both applications is incorporated herein by reference.

### TECHNICAL FIELD

The disclosure relates to a device for measuring a force acting on a king pin of a semitrailer. The disclosure also relates to a semitrailer and a to multi-part vehicle, including a tractor unit and a semitrailer.

### BACKGROUND

In particular, this disclosure relates to semitrailers, or towed vehicles, having an electrically drivable axle and to automated vehicles of Level 4 or higher according to SAE J3016 “Taxonomy and Definitions for Terms Related to Driving Automation Systems for On-Road Motor Vehicles” of 30 Apr. 2021.

Via a king pin, a semitrailer, or a towed vehicle, and a tractor vehicle having a fifth-wheel coupling can be connected to each other to form a multi-part vehicle. Accordingly, during operation, forces may act on the king pin that may reflect forces between the tractor vehicle and the towed vehicle. Such forces may be caused by a load, that is, a mass, of the semitrailer, but also by load changes, or driving dynamics. For example, during braking, the king pin may be subjected to a force that has a component counter to the direction of travel, and during acceleration to a force that has a component in the direction of travel.

For an automated driving function in particular, knowledge of the forces acting on the king pin may need to be taken into consideration, for example to enable deceleration of the semitrailer and/or propulsion of the semitrailer to be controlled.

U.S. Pat. No. 5,353,645 discloses a means for measuring deformation of a component. To reduce the effort involved in measuring deformation, an arrangement including a transmission element and one or two sensors is arranged in the component. The sensor is of a type having a measuring surface that emits an electrical signal dependent on a deformation of the measuring surface. The transmission element is supported on one side by a sensor and on the other side by the component or the other sensor. Upon deformation of the component, the separation between the support points of the transmission element changes. This change in separation results in a deformation of the measuring surface of the sensor, which is evaluated as a measure of the deformation of the component.

A method is thus known by which the bending of a fifth-wheel coupling support pin may be sensed with the aid of a sensing means in the support pin.

EP 0 607 855 A1 discloses a device for measuring and displaying the state of loading of a semitrailer. In order to improve a device for measuring and indicating the state of loading of a semitrailer so as to create a measuring device for determining the state of loading of the semitrailer that is also easy to handle, independently of the tractor unit, and that provides as accurate an indication as possible of the forces acting on the tractor unit, it being intended that the device should be as easy to handle as possible, it is disclosed that there is a pressure sensor or force sensor arranged on the support coupling between the tractor unit and the semitrailer.

Hitherto, it has not been possible to measure the horizontal, or radial, forces acting on the tractor vehicle at the king pin, in particular those that may act between the semitrailer and the tractor vehicle during braking or acceleration.

Instead, it is known to fasten the king pin via sensing screws, for example, and to measure the forces acting on the screws.

WO 2022/074010 A1 discloses a screw that has a strain gauge, and a king pin and a jaw coupling. The sensing screw, having a screw head, a screw shank adjoining the screw head along a screw axis, and having a thread realized on the screw shank, has a measuring means including a strain gauge that is arranged along or inside the screw shank and that senses strains of the screw shank in the direction of the screw axis, the measuring means having at least two electrical terminals that are located as contact points on an outer side of the sensing screw, and in particular are arranged in such a way that, when the sensing screw is inserted into a socket, they come into contact with two correlating electrical contacts of the socket. Additionally disclosed is a king pin for a fifth-wheel coupling, having a pin shaft, arranged at the first end of which there is a pin head, and arranged at the second end of which there is a fastening flange, the fastening flange having at least one clearance hole and with at least one screw connection, the sensing screw of this screw connection projecting through the clearance hole.

### SUMMARY

It is an object of the disclosure to provide an improved device for measuring a force acting on a king pin. In particular, the disclosure achieves the aforementioned object of reliably measuring a force acting on the king pin of a fifth-wheel coupling.

According to an aspect of the disclosure, a device is provided for measuring a

force acting on a king pin of a semitrailer. This device includes the king pin and a sensor device, and the sensor device is configured to ascertain a bending of the king pin caused by the force.

It has been recognized that the force acting on the king pin may cause deformation of the king pin, since the king pin is typically composed of a material, for example metal, that in particular allows elastic deformation due to the effect of the force. The force acting on the king pin can be ascertained by the sensor device via the deformation or, in particular, bending caused by the force. It has been recognized that the bending typically has a defined relationship to the acting force. Thus, the acting force can be deduced from the bending of the king pin.

It is thus possible to directly measure the bending of the king pin, and thus directly ascertain the force acting on the king pin, enabling reliable and precise measurement. There may therefore be no need to indirectly ascertain the force acting on the king pin based on forces acting on one or more sensing screws or bolts that, for example, fasten a fastening flange of the king pin to a skid plate of the semitrailer.

Optionally, the king pin has an opening, and the sensor device is arranged in the opening and/or at one end of the opening. The opening makes it possible to attach components of sensor device in a protected manner. Upon the king pin becoming bent, the opening also undergoes deformation, making it possible to ascertain the bending of the king pin in the opening and/or on the basis of a deformation of the opening.

Optionally, the king pin has a pin shank, and the opening is arranged within the pin shank. The pin shank may typically realize a relevant part of the bending, such that the opening within the pin shank may likewise undergo bending, which enables the bending of the king pin to be ascertained in an effective and reliable manner.

Optionally, the king pin has a pin head, and the opening extends through the pin shank into the pin head. The pin head may form one end of the king pin and therefore, upon bending of the king pin, undergo a comparatively large deflection, which can assist in effectively and reliably ascertaining the bending of the king pin.

Optionally, the king pin has a neutral axis, and the opening is arranged outside of the neutral axis. This neutral axis may be referred to as the zero line, as in strength of materials theory. The neutral axis is the fiber or layer of a cross-section of the king pin of which the length does not change upon bending, or more generally upon twisting and/or distortion. In the neutral axis, the bending does not cause any tensile or compressive stress. Outside of the neutral axis, the bending causes a change in length, and thus a tensile and/or compressive stress. The neutral axis may correspond to a longitudinal axis of the king pin. Having the opening arranged outside of the neutral axis enables the bending to be measured in a reliable manner. The sensitivity of a measurement and/or of the sensor device can be influenced by the distance between the opening to the neutral fiber.

Optionally, the king pin has a longitudinal axis, and the opening is arranged so as to extend parallel to the longitudinal axis. In other words, the opening may be arranged in such a way that the opening extends parallel to the longitudinal axis. The longitudinal axis may be an axis of rotation of the king pin and, in particular, of the pin shank and the pin head. Thus, between the opening and the longitudinal axis there is a distance that can influence the sensitivity of the measurement of the bending.

Optionally, the opening has a diameter of from 3 mm to 6 mm. The opening can thus be of sufficient dimensions to allow a component of the device to be arranged in the opening, and at the same time the opening can be small enough to have only an insignificant effect on the mechanical properties of the king pin. For example, the opening has a diameter of 4 mm.

Optionally, the device has a fluid arranged in the opening, and the sensor device has a fluid pressure sensor for measuring a pressure relating to the fluid. It has been recognized in this regard that the bending may result in a change in volume of the opening. This means that a fluid arranged in the opening may undergo a measurable change in pressure, which makes it possible to ascertain the bending.

Optionally, the device has a transmission element arranged in the opening, and the sensor device has a pressure sensor. The transmission element in this case may also be bent as a result of a bending the opening. The bending of the transmission element may result in a change in length of the transmission element, which causes a force that acts on the pressure sensor and that can be measured as pressure.

Optionally, the pressure sensor has a deformable diaphragm, and the transmission element is a partially threadless pressure rod that is supported on the pressure sensor, having a curved head for interaction with the diaphragm. The transmission element is thus supported with its head on the pressure sensor. The head may be curved convexly to allow movement on a surface of the diaphragm with a constant pressure acting on the diaphragm. The curved head forms a convex end of the pressure rod. The curvature of the head allows for a change in the orientation of the head upon a bending of the transmission element, to enable accurate measurement. The threadless pressure rod is an effective component of the device that can be arranged in the opening.

Optionally, the transmission element has a preload when the king pin is in a non-deformed state. Bending in different directions, resulting in relaxation and/or compression of the transmission element, can thus be measured. Depending on the direction of bending, a tensile or compressive stress that is measurable as pressure can be increased or decreased.

Optionally, the sensor device has a strain gauge arranged in the opening. This enables cost-effective measurement of the bending of the king pin, as the bending of the king pin may also cause bending of the opening and thereby cause a change in the length of the strain gauge. The change in length of the strain gauge may result in a correspondingly measurable electrical signal.

Optionally, the sensor device is configured to ascertain a bending of the king pin caused by a radial force. It has been recognized that the device not only makes it possible to measure a force acting axially on the king pin, which may, for example, provide an indication of the loading of the semitrailer, but that all forces, including radially acting forces, can be measured. The radially acting force may make it possible to quantify the driving dynamics, for example a difference in acceleration or deceleration between the tractor vehicle and the semitrailer.

Optionally, the sensor device has an electronic interface for communication connection between the sensor device and a brake system and/or an electric drive. This enables the braking system and/or the electric drive to be regulated in accordance with the force acting on the king pin, for example to enable an automated driving function to be performed and/or to enable the driving dynamics of the semitrailer to be matched to the driving dynamics of the tractor unit.

According to an aspect of the disclosure, a semitrailer is provided. The

semitrailer includes the device described above. The device in this case may include one or more of the optional features described above, in order to achieve an associated technical effect.

According to an aspect of the disclosure, a multi-part vehicle is provided. The multi-part vehicle includes a tractor unit and the semitrailer described above. The semitrailer in this case includes a device for measuring the force acting on the king pin. The device may have one or more of the optional features described above, in order to achieve an associated technical effect.

### BRIEF DESCRIPTION OF DRAWINGS

The invention will now be described with reference to the drawings wherein:

FIG. 1 shows a schematic representation of a multi-part vehicle as per an aspect of the disclosure;

FIG. 2 shows a further schematic representation of a multi-part vehicle as per an aspect of the disclosure;

FIG. 3 shows a schematic sectional representation of a device according to an embodiment as per an aspect of the disclosure;

FIG. 4 shows a schematic sectional representation of a device according to an embodiment as per an aspect of the disclosure; and,

FIG. 5 shows a schematic sectional representation of a device according to an embodiment as per an embodiment of the disclosure.

### DETAILED DESCRIPTION

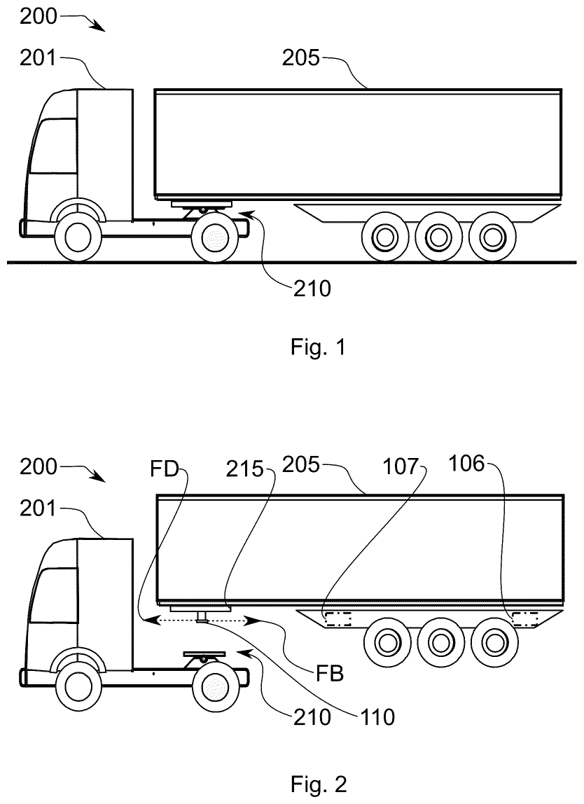

FIG. 1 shows a schematic representation of a multi-part vehicle 200 as per an aspect of the disclosure. The multi-part vehicle 200 is a commercial vehicle and a land vehicle.

The multi-part vehicle 200 includes a tractor unit 201 and a semitrailer 205, or towed vehicle. The tractor unit 201 is configured to be coupled to the semitrailer 205 to enable the semitrailer 205 to be towed. For this purpose, the tractor unit has a fifth-wheel coupling 210.

The multi-part vehicle 200 and the function of the fifth-wheel coupling 210 are described further with reference to FIG. 2.

FIG. 2 shows a further schematic representation of a multi-part vehicle 200 as per an aspect of the disclosure. FIG. 2 is described with reference to FIG. 1. Here, the tractor vehicle 201 and the semitrailer 205 are represented separately from one another in order to clarify the structure and function of the fifth-wheel coupling 210.

The semitrailer 205 includes a king pin 110 (see also FIGS. 3 to 5). The king pin 110 and the fifth-wheel coupling 210 are configured to be operatively connected to each other so that the tractor unit 201 can tow, or more generally move, the semitrailer 205.

When the semitrailer 205 and/or the tractor unit 201 are moving, forces FB, FD may act between the tractor unit 201 and the semitrailer 205, for example due to a difference in the accelerations of the tractor unit 201 and the semitrailer 205. The forces FB, FD between the tractor unit 201 and the semitrailer 205 cause and/or are forces FB, FD on the king pin 110. For example, in the case of a relative acceleration of the tractor unit 201, a force FD acting in the direction of the tractor unit 205 acts on the king pin 110; in the case of a relative braking of the tractor unit 201, there is a force FB acting in the direction of the semitrailer 205.

The semitrailer 105 includes a device 100 for measuring a force FB, FD acting on a king pin 110 of a semitrailer 205 (not shown in FIG. 2, see FIGS. 3 to 5). This makes it possible to measure the deformation in the king pin and thus, in particular, to sense the radial forces, or horizontal forces, between the tractor unit 201 and the semitrailer 205. This may then be used to effect regulation of the braking forces and/or to regulate an electric axle. For this purpose, the semitrailer 205 has a brake system 106 and an electric drive 107, which can be connected to the device 100 using communication technology and/or can be controlled by signals from the device 100.

FIG. 3 shows a schematic sectional representation of a device 100 according to an embodiment as per an aspect of the disclosure. The device 100 is a device 100 for measuring a force FB, FD acting on a king pin 110 of a semitrailer 205. Such a semitrailer 205 is described with reference to FIGS. 1 and 2. FIG. 3 is described with reference to FIGS. 1 and 2.

The device 100 according to FIG. 3 includes the king pin 110 and a sensor device 115.

The semitrailer 205 includes a skid plate 215, and the king pin 110 includes a fastening flange 121. The semitrailer 205 has a plurality of screw connections 220, via which the king pin 110 is mounted with the fastening flange 121 to the skid plate 215 of the semitrailer 205.

The skid plate 215 rests on the fifth-wheel coupling 210 of the tractor unit 201, and the king pin 110 engages in the fifth-wheel coupling 210.

The sensor device 115 is configured to ascertain a bending of the king pin 110 caused by the force FB, FD. The bending of the king pin 110 is, in particular, an elastic deformation of the king pin 110. As a result of the action of the force FB, FD (see FIG. 2), the king pin 110 may undergo deformation in such a way that the king pin 110 is in part deflected perpendicular to its longitudinal axis A.

The king pin 110 has an opening 112, part of the sensor device 115, or some of its components, being arranged in the opening 112 and at one end 112a of the opening 112. The opening 112 is a blind hole, or blind drilling, in the king pin 110. The opening 112 has a diameter d of from 3 mm to 6 mm.

The king pin 110 has a pin shank 111, and the opening 112 is arranged within the pin shank 111. The king pin 110 has a pin head 113, and the opening 112 extends through the pin shank 111 into the pin head 113. The opening 112 is cylindrical and thus defines a direction of main extent along a cylindrical axis of the opening 112. The opening 112 is arranged so as to extend parallel to the longitudinal axis A in the direction of main extent.

The king pin 110 has a neutral axis 114, and the opening 112 is arranged outside of the neutral fiber 114. The neutral axis 114 in this case is indicated only schematically outside of the longitudinal axis A. The neutral axis 114 may be coincident with the longitudinal axis A.

The device 100 has a transmission element 117 arranged in the opening 112, and the sensor device 115 has a pressure sensor 115b. The pressure sensor 115b has a deformable diaphragm 119, and the transmission element 117 is a partially threadless pressure rod 117′ that is supported on the pressure sensor 115, having a curved head 119a, as the convex end of the pressure rod 117′, for interaction with the diaphragm 119. The pressure rod 117′ is made, for example, from metal or another suitable elastically deformable material. A bending of the king pin 110 results in a bending of the pressure rod 117′, which may manifest itself as compressive or tensile stress. The compression or tension causes the head 119a of the pressure rod 117′ to interact mechanically with the diaphragm 119. The interaction of the head 119a of the pressure rod 117′ with the diaphragm 119 results in a deformation of the diaphragm 119, and thus in a pressure that can be measured, as an electrical signal, by the pressure sensor 115b. The transmission element 117 has a preload when the king pin 110 is in a non-deformed state.

Since it is possible to measure the bending of the king pin 110, the sensor device 115 is configured to ascertain the bending of the king pin 110 caused by a radial force FB, FD.

The sensor device 115 has an electronic interface 116 for communication connection between the sensor device 115 and a brake system 106 and/or an electric drive 107. The sensor device 115 outputs an analogue signal, for example, which corresponds to the pressure, and thus directly to the bending pin 110.

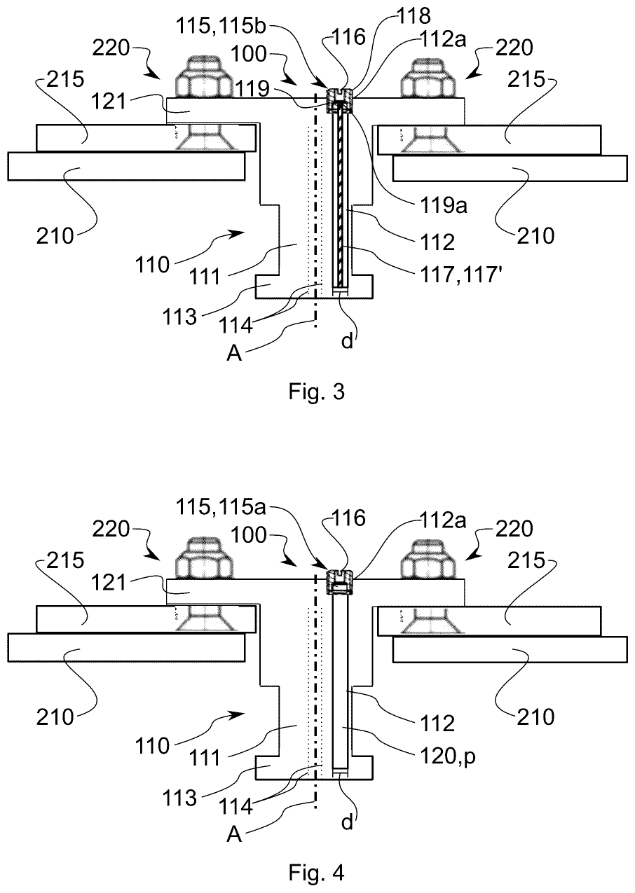

FIG. 4 shows a schematic sectional representation of a device 100 according to an embodiment as per an aspect of the disclosure. FIG. 4 is described with reference to FIG. 3. The differences between the embodiments of FIGS. 3 and 4 are described.

As shown in FIG. 4, the device 100 has a fluid 120 arranged in the opening 112, and a fluid pressure sensor 115a as a pressure sensor 115b. The fluid 120 is, for example, a liquid or a gas under pressure p. The sensor device 115 includes the fluid pressure sensor 115a for measuring the pressure p relating to the fluid 120. The fluid 120 is encapsulated in a fluid-tight manner in the opening 120 by the fluid pressure sensor 115a, and can thus cause a change in a pressure p upon a bending of the king pin 110.

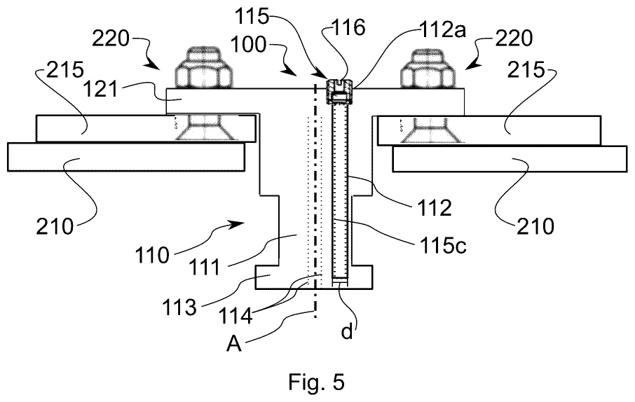

FIG. 5 shows a schematic sectional representation of a device 100 according to an embodiment as per an aspect of the disclosure. FIG. 5 is described with reference to FIG. 3. The differences between the embodiments of FIGS. 3 and 5 are described.

As shown in FIG. 5, the sensor device 115 has a strain gauge 115c, which is represented schematically by a rectangle with a dotted line and arranged in the opening 112. The strain gauge 115c is attached, for example by adhesive bonding, to a peripheral surface of the opening 112. A bending of the king pin 110 causes a bending of the opening 112, and thus a change in the length of the strain gauge 115c, which causes a change in the electrical resistance of the strain gauge 115c that can be measured by the sensor device 115.

A person skilled in the art will recognize that the embodiments of FIGS. 3 to 5 can be combined. To this end, the sensor device 115 may have a plurality of the features shown in FIGS. 3 to 5, for example a transmission element 117 and a fluid 120, a transmission element 117 and a strain gauge 120, a fluid 120 and a strain gauge 120, or a transmission element 117, a fluid 120 and a strain gauge 120, each with corresponding sensing means. The combinations allow the device 100 to ascertain the bending via a plurality of sensors, which may be used to check the plausibility of the forces FB, FD.

It is understood that the foregoing description is that of the preferred embodiments of the invention and that various changes and modifications may be made thereto without departing from the spirit and scope of the invention as defined in the appended claims.

### REFERENCE DESIGNATIONS (PART OF THE DESCRIPTION)

100 device
106 brake system
107 drive
110 king pin
111 pin shank
112 opening
112a end
113 pin head
114 neutral axis
115 sensor device
115a fluid pressure sensor
115b pressure sensor
115c strain gauge
116 electronic interface
117 transmission element
117′ pressure rod
118 metal housing
119 diaphragm
119a head
120 fluid
121 fastening flange
200 multi-part vehicle
201 tractor unit
205 semitrailer
210 fifth-wheel coupling
215 skid plate
220 screw connection
A longitudinal axis
d diameter
FB force, braking force
FD force, drive force
p pressure

1. A device for measuring a force acting on a king pin of a semitrailer, the device comprising:
said king pin and a sensor unit; and,
said sensor unit being configured to ascertain a bending of said king pin caused by said force.

2. The device of claim 1, wherein said king pin has an opening, and said sensor unit is arranged in at least one of the following locations: in the opening and at one end of the opening.

3. The device of claim 2, wherein said king pin has a pin shank, and said opening is arranged within said pin shank.

4. The device of claim 3, wherein said king pin has a pin head, and said opening extends through said pin shank into said pin head.

5. The device of claim 2, wherein said king pin has a neutral axis, and said opening is arranged outside of the neutral axis.

6. The device of claim 2, wherein said king pin defines a longitudinal axis, and said opening is arranged so as to extend parallel to the longitudinal axis.

7. The device of claim 2, wherein said opening has a diameter of from 3 mm to 6 mm.

8. The device of claim 2, wherein said device has a fluid arranged in the opening, and said sensor unit has a fluid pressure sensor for measuring a pressure relating to the fluid.

9. The device of claim 2, wherein said device further comprises a transmission element arranged in the opening, and said sensor unit has a pressure sensor.

10. The device of claim 9, wherein said pressure sensor has a deformable diaphragm, and said transmission element is a partially threadless pressure rod that is supported on said pressure sensor, having a curved head for interaction with said diaphragm.

11. The device of claim 9, wherein said transmission element has a preload when said king pin is in a non-deformed state.

12. The device of claim 2, wherein the sensor unit has a strain gauge arranged in said opening.

13. The device of claim 1, wherein the sensor unit is configured to ascertain a bending of said king pin caused by a radial force.

14. The device of claim 1, wherein the sensor unit has an electronic interface for communication connection between said sensor unit and at least one of the following: a brake system and an electric drive.

15. A semitrailer, comprising a device for measuring a force acting on a king pin of the semitrailer, the device including:
said king pin and a sensor unit; and,
said sensor unit being configured to ascertain a bending of said king pin caused by said force.

16. A multi-part vehicle, comprising:
a tractor unit and a semitrailer including a device for measuring a force acting on a king pin of the semitrailer, the device including:
said king pin and a sensor unit; and,
said sensor unit being configured to ascertain a bending of said king pin caused by said force.
